(19) United States
(12) Patent Application Publication
(10) Pub. No.: US 2008/0131716 A1
(43) Pub. Date: Jun. 5, 2008

(54) Shrinkable film barrier for mandrel tooling members

(75) Inventor: Michael D. Ridges, American Fork, UT (US)

Correspondence Address: THORPE NORTH & WESTERN, LLP., P.O. Box 1219, SANDY, UT, 84091-1219, US

(73) Assignee: American Consulting Technology & Research, Inc., Provo, UT (US)

(21) Appl. No.: 11/999,388

(22) Filed: Dec. 4, 2007

Related U.S. Application Data
(60) Provisional application No. 60/872,837, filed on Dec. 4, 2006.

(51) Int. Cl. B29C 65/66; B32B 27/32

(52) U.S. Cl. 428/523; 156/84

(57) ABSTRACT

A method for preparing a mandrel tooling member to receive a composite lay-up, the method comprising obtaining a mandrel tooling member having at least one working surface configured to support a composite lay-up; positioning a shrinkable material, in a pre-shrunk condition, about at least a portion of the mandrel tooling member and the working surface; and causing the shrinkable material to shrink and conform to the mandrel tooling member and the working surface to provide a barrier about the working surface.

### RELATED APPLICATIONS

This application claims the benefit of U.S. Provisional Application Ser. No. 60/872,837, filed Dec. 4, 2006, and entitled, “Shrinkable Film Barrier for Mandrel Tooling Members,” which is incorporated by reference in its entirety herein.

### FIELD OF THE INVENTION

The present invention relates generally to tooling for use in the fabrication of composite articles, namely mandrel or core tooling members, such as formable, disposable mandrels and polymer foam mandrels. More particularly, the present invention relates to various methods and devices used to provide a barrier about such mandrel tooling members and between the composite materials laid thereon to prevent migration of resin into the mandrel tooling member during manufacture of a composite article.

### BACKGROUND OF THE INVENTION AND RELATED ART

Mandrel or core tooling members for use in the fabrication or manufacture of composite articles are well known in the art. More specifically, these tooling members are used to fabricate composite articles having hollow cores, channels, or one or more voids. One particular type of composite article formed using a mandrel tooling member is a composite stringer. Mandrel tooling members typically comprise a quantity of one or more materials configured to provide or define one or more surfaces over which composite materials may be applied for the purpose of forming or fabricating a composite article. In essence, once the mandrel tooling member is formed, a barrier may be applied, and composite materials, such as a composite prepreg, may be laid up on the surface of the tooling member and the several components subjected to known composite forming processes, such as RTM or vacuum bagging, to form a composite article.

Currently there are two types of mandrel tooling members primarily used in the composites industry. The first comprises formable, disposable mandrel tooling members, and the second comprises polymer foam mandrel tooling members. Formable, disposable mandrel tooling members are designed to provide a destructible core. In other words, once the composite article has been formed, the mandrel may be destroyed (e.g., by spraying with a high power water jet stream), thus leaving the composite article devoid of any unnecessary material that may negatively affect the composite article, such as to increase its weight. As such, many of such mandrels are comprised of a water soluble material. This provides some advantages over non-destructible or non-disposable mandrels in the sense that many non-disposable mandrels remain with the formed composite article due to the difficulty in removing the mandrel. Formable, disposable mandrel tooling members are typically formed by mixing a filler material with a chemical binder. This formable composition is then packed into a female mold, whereupon pressure and heat is subsequently applied to produce the finished tooling having a surface over which composite materials may be applied for the purpose of fabricating a composite article.

Although useful, disposable mandrel tooling members have significant drawbacks. Perhaps the most significant drawback is the difficulty in sealing the surface. Without a good barrier or seal between the mandrel and the composite lay-up, resin may penetrate the surface and migrate into the interior of the mandrel as these typically comprise a rather porous material makeup. If this is permitted to happen, upon curing the composite lay-up supported on the surface of the mandrel, any resin that has migrated into the interior of the mandrel will also cure making it extremely difficult to separate the composite part from the mandrel, despite the advantage of the mandrel being disposable.

One conventional method of sealing formable, disposable mandrel tooling members is to wrap the surface with a Teflon or other similar tape. However, this is very labor intensive and time consuming, thus significantly increasing the cost of the composite articles fabricated. In addition, seams may be created that are not properly sealed and that may permit the migration of resin.

Another method for sealing formable, disposable mandrel tooling members comprises applying a liquid coating. However, current formulations are insufficient to provide a true non-porous surface. In addition, current formulations used for such an application require several coats, with each coat requiring a long cure time before the next one can be applied. In addition, these formulations must be cured in a high temperature environment, such as an oven. As such, applying conventional coatings is labor intensive and time consuming.

The second type of mandrel tooling members, namely polymer foam mandrel tooling members, typically comprise a high density, high temperature BMI (polybismaleimide) foam formed in accordance with known methods. The high density and high temperature characteristics permit the foam to withstand the somewhat extreme autoclave environment to which the foam will be subjected to during the manufacture of the composite article. Typical autoclave temperatures range from 300°-400° F. Typical autoclave pressures range from 80-100 psi. Using a high density, high temperature polymer foam prevents the foam from collapsing or compressing in the autoclave. One example of a high density, high temperature polymer foam commonly used in the composites industry is Rohacell™.

Polymer foam mandrel tooling members are commonly used to construct composite stringers, such as those used in the fabrication of airliners. However, despite their usefulness, foam mandrel tooling members have several drawbacks. Perhaps one of the most significant drawbacks is that they are not destructible or disposable, meaning they are not intended to be removed from the composite article once it is formed. Irregularities and bond strength between the foam mandrel and the composite are the primary reasons these foam mandrels remaining a permanent part of the formed composite article. Because of this added component, many composite articles formed using a foam mandrel are disadvantaged in a sense that they comprise one or more undesirable characteristics, one of which is excess weight. This is precisely the case in composite stringers in which the foam mandrel becomes part of the overall structure. In the case of airliners, the presence of foam in the several composite stringers making up the airliner can cause an increase in overall weight in excess of 5 tons.

Moreover, similar to disposable mandrel tooling members, foam mandrel tooling members utilize a barrier between the surface of the mandrel and the composite materials applied thereto. Conventional barriers commonly used in the art comprise a Teflon or other similar type tape with an adhesive backing. This barrier is intended to prevent resin migration into the interior of the mandrel to ensure the resin properly saturates the composite lay-up. Since this barrier is between the foam and the composite lay-up, in those cases where the foam remains a permanent part of the composite article, the barrier also remains. Unfortunately, this further adds to the overall weight of the composite article.

### SUMMARY OF THE INVENTION

In light of the problems and deficiencies inherent in the prior art, the present invention seeks to overcome these by providing an alternative to conventional barriers intended to be located about the surface of the mandrel tooling member and between the composite lay-up, and intended to provide a specific function, such as to seal the mandrel and to prevent or at least inhibit resin migration into the interior thereof. Specifically, the present invention provides a shrinkable film barrier for mandrel tooling members. The present invention also provides a method for forming composite articles using a formable, disposable or destructible mandrel tooling member, wherein the destructible mandrel tooling member is prepared for the composite lay-up by initially applying a shrinkable material to one or more surfaces thereof.

In accordance with the invention as embodied and broadly described herein, the present invention resides in a method for preparing a mandrel tooling member to receive a composite lay-up, the method comprising obtaining a mandrel tooling member having at least one working surface configured to support a composite lay-up; positioning a shrinkable material, in a pre-shrunk condition, about at least a portion of the mandrel tooling member and the working surface; and causing the shrinkable material to shrink and conform to the mandrel tooling member and the working surface to provide a barrier about the working surface.

The present invention also features a method for forming a composite article, the method comprising obtaining a mandrel tooling member having at least one working surface configured to receive a composite lay-up; positioning a shrinkable material, in a pre-shrunk condition, about at least a portion of the mandrel tooling member and the working surface; causing the shrinkable material to shrink and conform to the mandrel tooling member and the working surface, and to provide a barrier about the working surface; causing the shrinkable material, once shrunk, and the working surface to receive a composite prepreg; and forming a composite article about the mandrel tooling member from the composite prepreg.

The present invention further features a mandrel tooling member for use in the manufacture of a composite article, the mandrel tooling member comprising a mandrel core defining at least one working surface configured to support a composite lay-up; and a shrinkable material configured for disposal about at least a portion of the mandrel core and the working surface, the shrinkable material comprising a pre-shrunk condition facilitating initial positioning about the mandrel core, and a shrunk condition resulting from the shrinkable material being caused to conform to the mandrel core, the shrinkable material providing a barrier about the working surface.

The present invention still further features a method for forming a composite stringer comprising obtaining a formable, disposable mandrel tooling member having at least one working surface configured to support a composite lay-up; positioning a shrinkable material, in a pre-shrunk condition, about at least a portion of the mandrel tooling member and the working surface; causing the shrinkable material to shrink and conform to the mandrel tooling member and the working surface, and to provide a barrier about the working surface; situating the mandrel tooling member, having the shrinkable material shrunk thereto, about a composite lay-up supported within a mold-type tooling member; laying up additional composite prepreg over the mandrel tooling member; forming a composite stringer about the mandrel tooling member from the composite prepreg; and destroying the mandrel tooling member once the composite stringer is formed to obtain a hollow channel.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a partial perspective view of a shrinkable material in the form of a shrink sleeve configured and intended to fit over the outer surface of a mandrel tooling member in a pre-shrunk condition, in accordance with one exemplary embodiment of the present invention;

FIG. 2 illustrates a cross-sectional view of the pre-shrunk shrinkable material and the mandrel tooling member of FIG. 1 as the shrinkable material it is fitted over the outer surface of the mandrel tooling member;

FIG. 3 illustrates a partial perspective view of a shrinkable material in the form of a continuous shrink wrap film configured and intended to be disposed about the outer surface of a mandrel tooling member in a pre-shrunk condition, in accordance with another exemplary embodiment of the present invention;

FIG. 4 illustrates a cross-sectional view of a shrinkable material in a shrunk condition as it is caused to conform to the outer surface of a mandrel tooling member in accordance with one exemplary embodiment; and

FIG. 5 illustrates a method for preparing a mandrel tooling member to receive a composite lay-up in accordance with one exemplary embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a method and system for preparing a mandrel tooling member to receive and support a composite lay-up. More specifically, the present invention describes a shrinkable material configured for use with a mandrel tooling member, wherein the shrinkable material may be applied to the surface of a mandrel tooling member in a pre-shrunk condition, and subsequently activated to shrink and conform to the mandrel tooling member, thus providing a barrier (e.g., a sealant) over the mandrel tooling member and between a composite prepreg to be applied thereto. One of the primary functions of the shrinkable material, as a barrier, is to prevent resin from the composite prepreg from migrating through the surface of the mandrel tooling member and into its core.

The present invention provides several significant advantages over prior related mandrel tooling member sealing materials and methods, some of which are recited here and throughout the following more detailed description. First, using a shrinkable material provides a quick and efficient way to seal the surface of the mandrel tooling member. Second, a shrinkable material, once activated, provides a tight, wrinkle-free fit over the mandrel tooling member. Third, a shrinkable material provides an effective way to seal formable, disposable mandrel tooling members. This is advantageous in that such formable, disposable mandrel tooling members may be used in applications where they otherwise have not been applicable, such as in the manufacture of composite stringers. For example, by manufacturing composite stringers using a disposable or destructible mandrel tooling member, this can be destroyed and eliminated from the composite stringer once formed, thus significantly reducing the weight of the composite stringer as compared to one formed using a polymer foam mandrel tooling member that remains a permanent part of the composite stringer. However, sealing such mandrels has proven difficult using conventional methods.

Each of the above-recited advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

As used herein, the term “disposable, formable mandrel tooling member” or “destructible mandrel tooling member” shall be understood to mean any type of mandrel capable of being formed into a desired geometric configuration, and comprising a composition that is disposable, or that is capable of being destroyed once the composite article is fabricated. Disposable tooling members are intended to comprise various types known in the art, such as water-soluble tooling mandrels, as well as those types used in bladder molding processes, such as urethane foam compositions.

The term “working surface,” as used herein, shall be understood to mean all or part of a surface of a tooling member, and particularly a tooling core, configured to come in contact with and support a composite lay-up for the fabrication of a composite article.

The term “barrier,” as used herein, shall be understood to mean the layer of shrunk material situated about the mandrel surface and configured to be between the mandrel surface and a composite prepreg. The term barrier is intended to comprise an element of sealability to prevent resin migration from the composite prepreg through the surface of the mandrel tooling member and into the mandrel core.

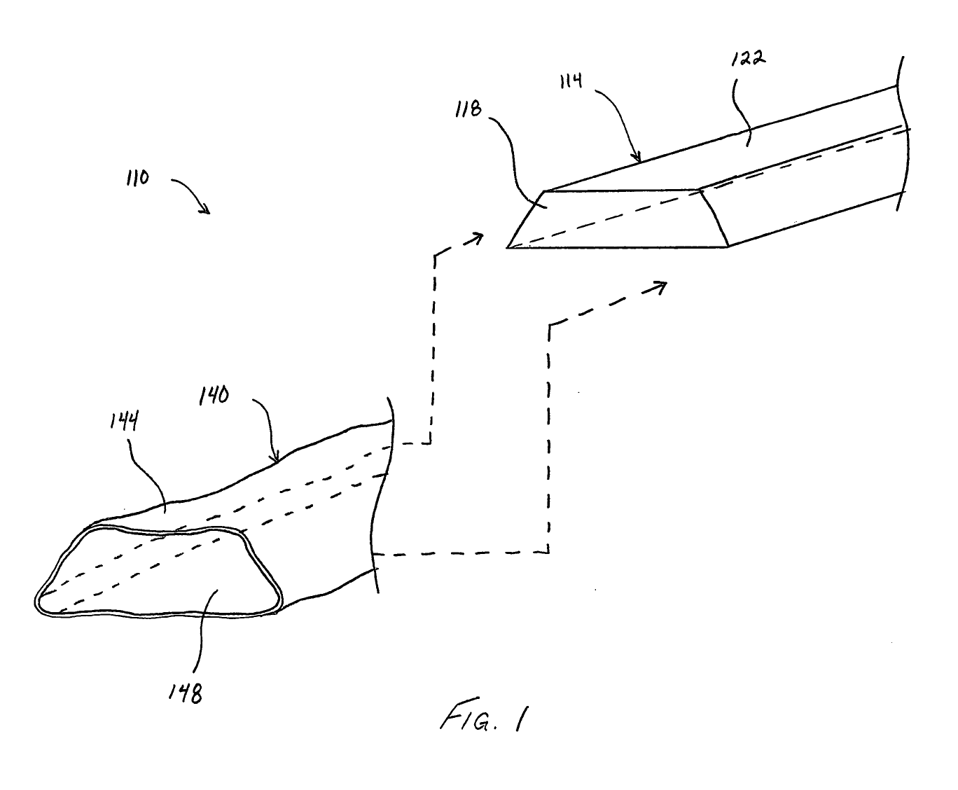

With reference to FIG. 1, illustrated is a sealing system for a mandrel tooling member in accordance with one exemplary embodiment of the present invention, wherein the sealing system comprises a shrinkable material operable with a mandrel tooling member. As shown, the sealing system 110 comprises a mandrel tooling member 114 having a mandrel core 118 defining a surface 122, at least some of which is intended to comprise a working surface configured to receive or have applied thereto and support a composite lay-up, such as a prepreg. The mandrel tooling member 114 may comprise any desired geometry and/or configuration, including one with a uniform cross-section, one with a non-uniform cross-section, and/or one with an arbitrary configuration, thus permitting any desired surface configuration. For example, the mandrel tooling member 114 may be sized and configured to function as a mandrel for the fabrication of composite stringer members.

In one aspect of the present invention, and with respect to all embodiments discussed herein, the mandrel tooling member may comprise a formable, disposable or destructible mandrel tooling member configured to be destroyed and removed or separated from the composite article once it is formed. For example, the formable disposable mandrel tooling member may comprise a water soluble mandrel tooling member that may be washed or sprayed away with water after formation and curing of the composite article. Exemplary types and compositions of water-soluble mandrel tooling members, as well as methods for removing such tooling members from composite articles, are set forth in U.S. Pat. No. 6,828,373 to Artz et al.; U.S. Publication No. 2002/0173575 to Artz et al.; U.S. Publication No. 2004/0195713 to Hansel; and U.S. Publication No. 2005/0116136 to Artz et al., each of which are incorporated by reference herein. Other types of disposable mandrel tooling members include those made from eutectic salt, sodium silicate-bonded sand, and poly(vinyl alcohol) bonded ceramic microspheres.

In another aspect of the present invention, the mandrel tooling member may comprise a polymer or other type of foam mandrel tooling member that may or may not be removed or separated from the composite article once formed. Essentially, it is contemplated that the present invention shrinkable material, and the methods for using and applying this with/to the mandrel, may be utilized with any type of mandrel used in the fabrication of composite articles. While the shrinkable material is contemplated for use with mandrel tooling members having a porous makeup, it is also contemplated that the shrinkable material may be used with semi or non-porous mandrel tooling members.

In still another aspect of the present invention, the mandrel tooling member may comprise a collapsible mandrel, which are commonly known. These collapsible mandrel tooling members may be formed from various materials, including, but not limited to, metal, polymer, composite, or ceramic materials.

The working surface of the tooling member may comprise all or a portion of an outside surface of the tooling core. The working surface is intended to support a composite lay-up, such as a prepreg, as applied to the working surface in any known manner.

The mandrel sealing system 110 further comprises a shrinkable material. In the embodiment shown in FIG. 1, the shrinkable material is in the form of a shrink sleeve 140 having a tube-like configuration with a wall structure 144 and an interior 148 defined by the wall structure 144. The shrink sleeve 140 is sized and configured to fit over the outer surface 122 of the mandrel core 118, and thus comprises an interior 148 having a larger dimension (e.g., greater cross-sectional area) than the outer surface dimension of the mandrel core 118. In this manner, the mandrel tooling member 114 may be received into the interior 148 of the shrink sleeve 140 and manipulated in place prior to being activated to shrink.

As shown, the shrink sleeve 140 comprises a seamless configuration. However, other shrink sleeves having one or more seams, if necessary, is also contemplated for use.

In addition, FIG. 1 illustrates a single shrink sleeve 140 as being intended to receive the mandrel tooling member 114. As will be recognized by those skilled in the art, a plurality of shrink sleeves may be fitted about a mandrel tooling member to provide the desired barrier about the surface of the mandrel tooling member and between the composite prepreg to be applied thereto. These may be sealed or bonded to one another if necessary to sufficiently prevent resin migration. Or, they may positioned to overlap so that upon shrinking they effectively become a unitary barrier.

With respect to all embodiments discussed herein, the shrinkable material comprises two states or conditions, namely a pre-shrunk condition and a shrunk condition. In the pre-shrunk condition, the shrinkable material facilitates application to and fitting about the mandrel tooling member. In other words, it is intended that the shrinkable material be applied to the mandrel tooling member in a pre-shrunk condition prior to being activated. In this condition, the shrinkable material is easy to handle and manipulate about the mandrel tooling member since it will most likely be sized in accordance with the mandrel tooling member to fit loosely thereabout. Subsequently, once properly positioned about the mandrel tooling member, the shrinkable material may be activated and caused to shrink and conform to the surface of the mandrel tooling member, thus creating a form-fitted barrier, and particularly a sealant, about the mandrel tooling member.

The shrinkable material may comprise any type of composition or material makeup suitable for preventing resin migration, and which is capable of existing in a pre-shrunk condition, subsequently to be activated by one or more elements to cause the shrinkable material to shrink and conform to an object and its surface(s). There are several different types of shrinkable materials currently in existence that may be adapted for use with the present invention. For example, the shrinkable material may comprise a fluorinated polymer, such as a fluorinated ethylene propylene copolymer (FEP). The shrinkable material may also be formed from perfluoroalkoxy copolymer PFA, or other resins. Other types of shrinkable materials may include polyvinyl chlorides (PVC), polyethylene terepthalates (PET), and polyolefins. Those skilled in the art will recognize others as well. In one exemplary embodiment, the shrinkable material may comprise Viton®. Those types of shrinkable materials described above comprise are heat activated. In other words, the shrinkable materials discussed above are caused to shrink and conform to the mandrel tooling member upon the application of heat by one or more heating means. Various water activated shrinkable materials are also contemplated for use.

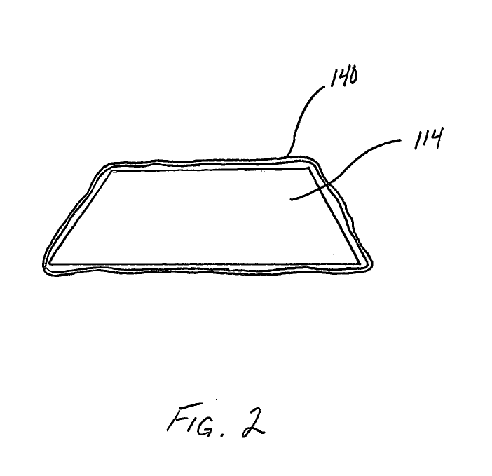

FIG. 2 illustrates a cross-sectional view of the pre-shrunk shrink sleeve 140 and the mandrel tooling member 114 of FIG. 1 as the shrink sleeve 140 it is fitted over the outer surface 122 of the mandrel tooling member 114. As can be seen, the shrink sleeve 140 fits loosely over the mandrel tooling member 114, but not so loose so as to provide excess material. Indeed, the size of the shrink sleeve 140, in its pre-shrunk state, will most likely correspond closely to the size of the mandrel tooling member 114.

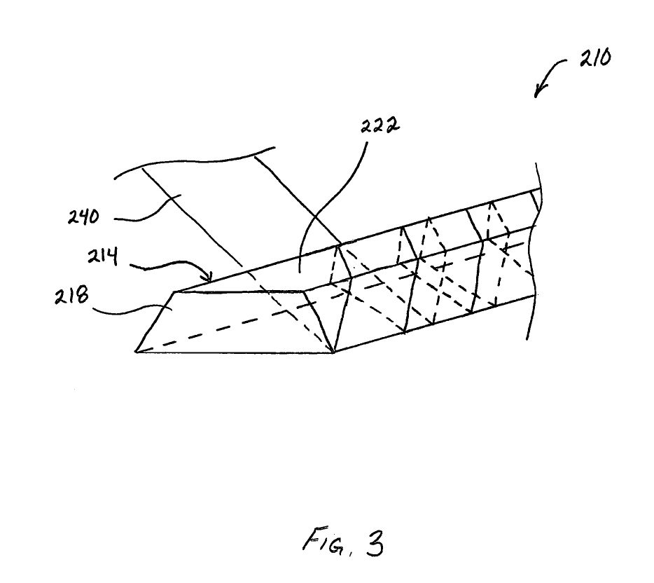

With reference to FIG. 3, illustrated is a sealing system for a mandrel tooling member in accordance with another exemplary embodiment of the present invention, wherein the sealing system comprises a shrinkable material operable with a mandrel tooling member. As shown, the sealing system 210 comprises a mandrel tooling member 214 having a mandrel core 218 defining a surface 222, at least some of which is intended to comprise a working surface configured to receive or have applied thereto and support a composite lay-up. The mandrel sealing system 210 further comprises a shrinkable material, which, in the embodiment shown, is in the form of a continuous shrink wrap or shrink wrap film 240 configured and intended to be disposed about the outer surface of the mandrel tooling member 214 in a pre-shrunk condition. Using a shrink wrap film, the mandrel tooling member 214 may be wrapped in one or more ways to cover the surface(s) 222 of the mandrel tooling member. Although one or more seams or gaps may be formed as the shrink wrap is wrapped around the mandrel tooling member, overlaying the leading edge of the shrink wrap over the trailing edge will allow a seal to be formed between the two layers of shrink wrap once the shrink wrap is activated and caused to shrink to conform to the mandrel tooling member. Other means may be used to seal any gaps or seams created by wrapping the shrink wrap about the mandrel tooling member.

It is noted herein that although FIG. 3 illustrates a continuous shrink wrap film being applied to a mandrel tooling member, and FIG. 1 illustrates a shrink sleeve, those skilled in the art will recognize and appreciate that one or more shrink sheets or shrink sheet films may also be used. Shrink sheets may be particularly advantageous when trying to provide a barrier about an odd or arbitrarily shaped mandrel tooling member. In addition, any combination of sheets, wraps, and sleeves may be used.

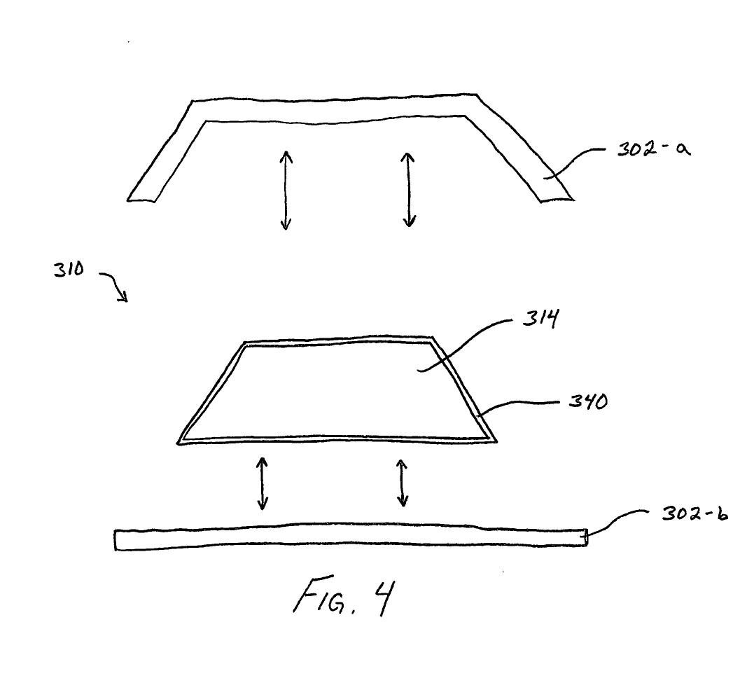

FIG. 4 illustrates a cross-sectional view of a mandrel sealing system 310, wherein the shrinkable material 340 exists in its shrunk condition subsequent to being activated and caused to conform to the outer surface of the mandrel tooling member 314.

FIG. 4 further illustrates composite prepregs 302-a and 302-b, each of which are intended to represent different manufacturing methods for fabricating a composite article. For example, in one aspect, the mandrel tooling member with its shrinkable material barrier may be used in a composite article manufacturing process in which the composite prepreg is laid up or applied over the surface of the shrinkable material and the mandrel tooling member. In another aspect, the mandrel tooling member, with its shrinkable barrier, may be applied to an existing composite lay-up situated within a mold-type tooling member, wherein additional composite prepreg may be laid up over the mandrel tooling member, such as in the formation of composite stringer members. Nonetheless, it is contemplated that the mandrel tooling member receive and support a composite lay-up for the formation of a composite article in any manner as commonly known in the art.

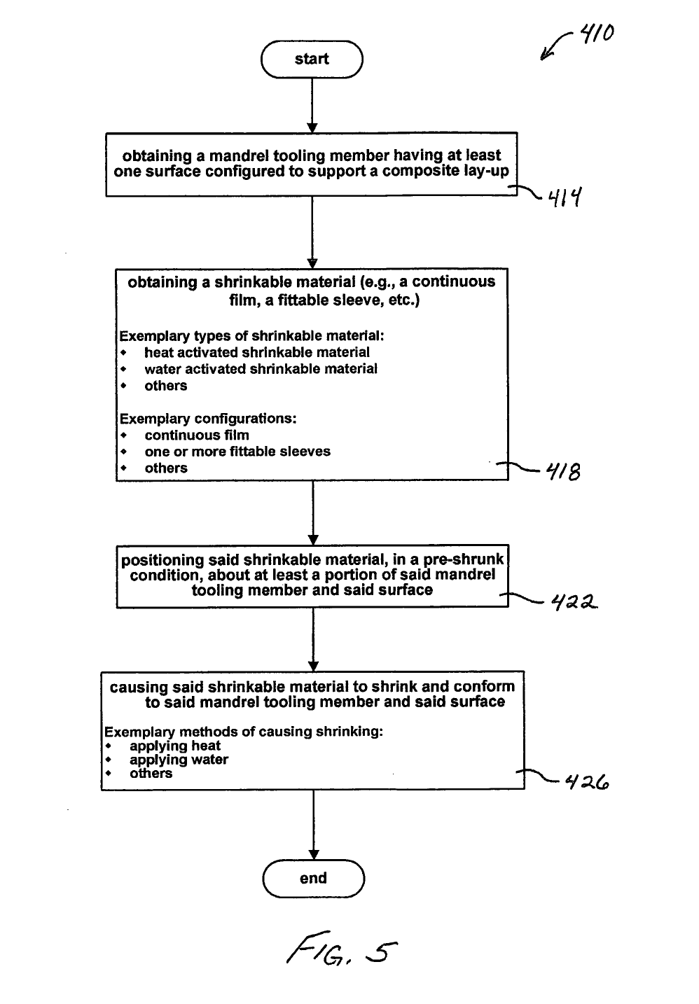

With reference to FIG. 5, illustrated is a method for preparing a mandrel tooling member to receive a composite lay-up in accordance with one exemplary embodiment of the present invention. As shown, the method 410 comprises step 414, obtaining a mandrel tooling member having at least one surface configured to support a composite lay-up. Step 418 comprises obtaining a shrinkable material. Step 422 comprises positioning the shrinkable material, in a pre-shrunk condition, about at least a portion of the mandrel tooling member and the working surface. Step 426 comprises causing the shrinkable material to shrink and conform to the mandrel tooling member and the working surface to form a barrier or seal that resists resin migration into the mandrel tooling member. The method may comprise additional steps of destroying or disposing of the mandrel tooling member once the composite article is formed, or as needed.

With respect to step 418 and 426, exemplary types of shrinkable materials are discussed above and include heat activated shrinkable materials utilizing means for applying heat to the shrinkable material, water activated shrinkable materials utilizing means for applying water to the shrinkable material, and any others known in the art. In addition, exemplary configurations of shrinkable materials, also discussed above, include continuous shrink wrap or film, one or more shrink sleeves, one or more shrink sheets, and any others known in the art.

As indicated above, one particular advantageous application of the present invention may be in the fabrication of composite stringer members. As such, the present invention provides exemplary methods for forming a composite stringer. The method is similar to the one discussed above and shown in FIG. 5, but further comprises situating the mandrel tooling member, having the shrinkable material shrunk thereto, about a composite lay-up supported within a mold-type tooling member; laying up additional composite prepreg over the mandrel tooling member; forming a composite stringer about the mandrel tooling member from the composite prepreg; and destroying the mandrel tooling member once the composite stringer is formed to obtain a hollow channel. This method further comprises removing the shrinkable material from the hollow channel of the composite stringer once the mandrel tooling member is destroyed.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A method for preparing a mandrel tooling member to receive a composite lay-up, said method comprising:
obtaining a mandrel tooling member having at least one working surface configured to support a composite lay-up;
positioning a shrinkable material, in a pre-shrunk condition, about at least a portion of said mandrel tooling member and said working surface; and
causing said shrinkable material to shrink and conform to said mandrel tooling member and said working surface, said shrinkable material providing a barrier about said working surface against resin migration.

2. The method of claim 1, further comprising subjecting said shrinkable material to one or more finishing processes to better fit said mandrel tooling member.

3. The method of claim 1, further comprising causing said shrinkable material to bond to said mandrel tooling member.

4. The method of claim 1, wherein said causing said shrinkable material to shrink and conform to said mandrel tooling member and said working surface comprises applying heat to said shrinkable material to activate a shrinking process of said shrinkable material.

5. The method of claim 1, wherein said causing said shrinkable material to shrink and conform to said mandrel tooling member and said working surface comprises applying water to said shrinkable material to activate a shrinking process of said shrinkable material.

6. The method of claim 1, wherein said shrinkable material is optimally sized and configured to fit said mandrel tooling material and said working surface.

7. The method of claim 1, wherein said obtaining a shrinkable material comprises obtaining a continuous film of shrink wrap configured to be disposed about said mandrel tooling material and said working surface.

8. The method of claim 1, wherein said obtaining a shrinkable material comprises obtaining a plurality of sheets of shrinkable material configured to be disposed about said mandrel tooling material and said working surface.

9. The method of claim 1, wherein said obtaining a shrinkable material comprises obtaining a shrink sleeve sized and configured to receive said mandrel tooling material, said shrink sleeve comprising a tube-like configuration with an inner dimension, in said pre-shrunk condition, slightly larger than an outer dimension of said mandrel tooling member.

10. The method of claim 1, wherein said obtaining a mandrel tooling member comprises obtaining a formable, disposable mandrel tooling member, and wherein said method further comprises destroying said mandrel tooling member upon formation of a composite article.

11. The method of claim 1, wherein said obtaining a mandrel tooling member comprises obtaining a non-destructible polymer foam mandrel tooling member.

12. The method of claim 1, wherein said obtaining a mandrel tooling member comprises obtaining a collapsible mandrel.

13. A method for forming a composite article, said method comprising:
obtaining a mandrel tooling member having at least one working surface configured to receive a composite lay-up;
positioning a shrinkable material, in a pre-shrunk condition, about at least a portion of said mandrel tooling member and said working surface;
causing said shrinkable material to shrink and conform to said mandrel tooling member and said working surface, and to provide a barrier about said working surface against resin migration;
causing said shrinkable material, once shrunk, and said working surface to receive a composite prepreg; and
forming a composite article about said mandrel tooling member from said composite prepreg.

14. The method of claim 13, further comprising separating said composite article from said mandrel tooling member once said composite article is formed.

15. The method of claim 14, wherein said step of separating comprises destroying or disposing of said mandrel tooling member.

16. The method of claim 13, wherein said step of forming comprises:
sealing said composite prepreg;
applying a resin to said composite prepreg; and
curing said composite prepreg and said resin to form said composite article.

17. The method of claim 13, wherein said causing said shrinkable material and said working surface to receive a composite prepreg comprises laying up a composite prepreg over said shrinkable material and about said working surface.

18. The method of claim 13, wherein said causing said shrinkable material and said working surface to receive a composite prepreg comprises situating said mandrel over a composite prepreg lay-up, wherein said composite prepreg is supported by a mold-type tooling member.

19. A mandrel tooling member for use in the manufacture of a composite article, said mandrel tooling member comprising:
a mandrel core defining at least one working surface configured to support a composite lay-up; and
a shrinkable material configured for disposal about at least a portion of said mandrel core and said working surface to prevent resin migration into said mandrel core, said shrinkable material comprising a pre-shrunk condition facilitating initial positioning about said mandrel core, and a shrunk condition resulting from said shrinkable material being caused to conform to said mandrel core, said shrinkable material providing a barrier about said working surface.

20. The mandrel tooling member of claim 19, wherein said shrinkable material comprises a continuous shrink wrap film configured to be disposed on said mandrel tooling member.

21. The mandrel tooling member of claim 19, wherein said shrinkable material comprises a shrink sleeve sized and configured to fit over said mandrel tooling member.

22. The mandrel tooling member of claim 21, wherein said shrink sleeve is seamless.

23. The mandrel tooling member of claim 19, wherein said shrinkable material is heat-activated to achieve said shrunk condition.

24. The mandrel tooling member of claim 19, wherein said shrinkable material is water-activated to achieve said shrunk condition.

25. The mandrel tooling member of claim 19, wherein said shrinkable material comprises a material makeup selected from the group consisting of a fluorinated polymer, a fluorinated ethylene propylene copolymer, a perfluoroalkoxy copolymer, a polyvinyl chloride, Viton®, and a polyethylene terepthalate and a polyolefin.

26. The mandrel tooling member of claim 19, wherein said mandrel core comprises a formable, disposable material used to form destructible mandrel tooling members.

27. The mandrel tooling member of claim 19, wherein said mandrel core comprises a polymer foam material.

28. The mandrel tooling member of claim 18, wherein said mandrel core comprises a collapsible mandrel.

29. The mandrel tooling member of claim 19, wherein said mandrel core comprises a non-uniform cross-section.

30. A method for forming a composite stringer comprising:
obtaining a formable, disposable mandrel tooling member having at least one working surface configured to support a composite lay-up;
positioning a shrinkable material, in a pre-shrunk condition, about at least a portion of said mandrel tooling member and said working surface;
causing said shrinkable material to shrink and conform to said mandrel tooling member and said working surface, and to provide a barrier about said working surface;
situating said mandrel tooling member, having said shrinkable material shrunk thereto, about a composite lay-up supported within a mold-type tooling member;
laying up additional composite prepreg over said mandrel tooling member;
forming a composite stringer about said mandrel tooling member from said composite prepreg; and
destroying said mandrel tooling member once said composite stringer is formed to obtain a hollow channel.

31. The method of claim 30, further comprising removing said shrinkable material from said hollow channel of said composite stringer once said mandrel tooling member is destroyed.
